(19) United States
(12) Patent Application Publication
(10) Pub. No.: US 2004/0023636 A1
(43) Pub. Date: Feb. 5, 2004

(54) Wireless prepaid payphone system and cost control application

(75) Inventor: Peretz Gurel, Nir Zevi (IL)

Correspondence Address: SUGHRUE MION, PLLC, 2100 PENNSYLVANIA AVENUE, N.W., WASHINGTON, DC, 20037, US

(73) Assignee: COMVERSE NETWORK SYSTEMS, LTD.

(21) Appl. No.: 10/207,782

(22) Filed: Jul. 31, 2002

(51) Int. Cl. H04M 11/00

(52) U.S. Cl. 455/405; 455/406

(57) ABSTRACT

A wireless prepaid payphone system provides simple and efficient payphone service in a wireless communications network. A payphone interface is added to a prepaid server of the wireless network, enabling real-time communication between the prepaid server and a payphone application running in a wireless/mobile handset. This real-time communication allows the payphone application to automatically and accurately calculate the amount to be charged for each call, as well as keeping track of an accumulated total for all the calls made. The total price/cost for a made call and the accumulated price/cost for all the calls made are displayed on the handset for easy viewing. Additionally, a cost control application allows limits to be placed on the usage, as it relates to the cost incurred, of the wireless handset.

### BACKGROUND OF THE INVENTION

1. Field of the Invention

The present invention relates to a wireless prepaid payphone system and cost control application.

2. Background and Related Art

In many developing countries, wireless systems, for example cellular telephone systems, Wireless Local Loop (WLL) systems, etc., are deployed as a quick way to provide telephone service where wireline infrastructure is not available. The most common mode of payment for this phone service is prepaid, i.e. the user pays up front and receives the right to make phone calls until the prepaid amount is used up.

This procedure works fairly well when the handset owner is the only person making calls. This procedure does not work well when the handset owner allows others to use the handset to make calls. For example, there are people with prepaid wireless handsets who are willing to loan their handsets for use by other people in exchange for a fee. “Owner” represents a person who owns or controls a handset, and “Loanee” represents the person who wants to borrow this handset to make a call. One system that is used today for this type of transaction is illustrated by the following actions:

The Owner makes a call to the prepaid server to find out what is his current balance.

The Owner loans the phone to the Loanee to make a call.

After the Loanee completes his call, the Owner makes another call to the prepaid server to find out what is his new balance.

The Owner manually calculates the difference (between the current balance and the new balance) and adds his fee to determine the price of the call made by the Loanee.

Many handsets today have a cost control function in the form of an internal meter that measures the time for outgoing calls, which can be translated to cost (e.g., on the basis of the cost-per-minute of the call). However, because there are various payment plans as well as value added services (e.g., SMS) that are not supported by this feature, a handset user cannot rely on the information provided by current handsets, and has to call customer service to get his current balance. In addition, such current handset features currently do not support discontinuing communication via the handset when a predetermined cost has been reached.

Another approach that may also be used today is simply for the Owner and the Loanee to agree beforehand what will be the charge for the call (either flat fee or price per minute), and in this way simplify the transaction.

These conventional approaches to providing wireless payphone services suffer from numerous disadvantages. For example, the approach of calling the prepaid server to determine the current balance, both before and after a call, is inconvenient because it requires two additional calls for each call/transaction. While these calls are usually free for the end user, this is an inefficient approach that requires additional time and effort on the part of the Owner. Also, these additional calls place an added hardship on the Network Operator by consuming network resources.

In addition, this approach requires manual calculations of the cost and price, as well as requiring the Owner to remember/record the current balance so that it can eventually be compared to the new balance.

Because the Owner makes the calls to the prepaid server and the Loanee does not hear the information provided by the prepaid server, the door is opened for mistrust and arguments between the parties.

The approach of agreeing beforehand as to the price for wireless payphone service also suffers from disadvantages. For example, the approach is too simplistic, almost always resulting in overcharging or undercharging, such that a fair commercial transaction is hampered and/or one of the parties is dissatisfied.

### OBJECTS AND BRIEF SUMMARY OF THE INVENTION

It is thus an object and advantage of the invention to provide a more efficient wireless prepaid payphone system, wherein no additional calls are required to determine the current and previous balance.

It is a further object and advantage of the invention to provide a wireless prepaid payphone system, wherein a wireless prepaid payphone automatically calculates all cost and price information.

It is yet another object and advantage of the invention to provide a wireless prepaid payphone system, wherein pricing information is openly presented on the handset's display, thus reducing the likelihood of any misunderstanding and mistrust developing between the parties.

A still further object and advantage of the invention is to provide a wireless prepaid payphone with a display that is used to present cost incurred information on a per call and accumulated basis, in a more accurate and user-friendly manner.

It is yet another object and advantage of the invention to provide a wireless prepaid payphone system that insures accurate pricing, which covers the actual cost of a call and allows for an agreed-upon and equitable margin.

A still further object and advantage of the invention is to provide a wireless prepaid payphone system that allows pricing of additional services, in addition to regular telephone service.

It is yet another object and advantage of the invention to provide a wireless prepaid payphone system incorporating various security measures including, for example, a cost control application, wherein a limit can be placed upon the amount of usage of the payphone system by a user.

In summary, the invention provides a better way of implementing a payphone service in a wireless communications network, a way that is more efficient and economical to the Network Operator, and much more effective and user friendly to the users of the service.

An additional application of the invention is in the area of cost control. Consider for example a father who gives his prepaid mobile handset to his daughter. Today there is no way to limit the daughter's usage of the phone beyond the prepaid amount. Thus, the daughter may use the full outstanding balance of the prepaid account. Using the invention, however, the father can very simply set a limit on the daughter's usage of the handset.

Yet another application of the invention is for a system that provides prepaid phone service in a wired or wireless communications network, such as by a prepaid calling card.

### BRIEF DESCRIPTION OF THE DRAWING FIGURES

Features and advantages of the present invention will become apparent to those skilled in the art from the following description with reference to the drawings, in which:

FIG. 1 shows an illustrative system according to one non-limiting embodiment of the present invention.

FIGS. 2A and 2B are flow charts describing the operation of the wireless prepaid phone system of FIG. 1.

FIGS. 3A, 3B, and 3C are flow charts for describing the operation of the wireless prepaid phone system of FIG. 1, including a cost control application.

### DETAILED DESCRIPTION OF THE PREFERRED EMBODIMENTS

In the following detailed description of the preferred embodiments, reference is made to the accompanying drawings, which form a part hereof and in which is shown, by way of illustration, a specific embodiment in which the invention may be practiced. The following detailed description is, therefore, not to be taken in a limiting sense and the scope of the present invention is defined by the appended claims.

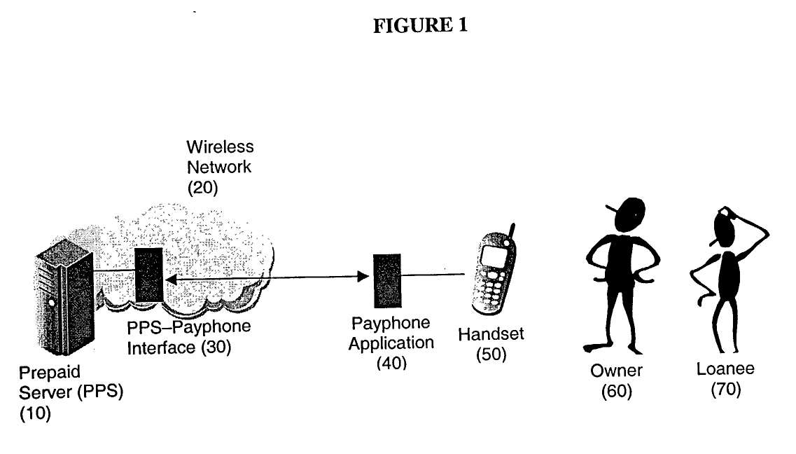

Depicted in FIG. 1 is an exemplary embodiment of the wireless prepaid payphone system. The system adds a PPS-Payphone Interface (30) to a PPS (10) and a payphone application (40) to a handset (50), operating in a conventional wireless communications network (20). A PPS is a server in the wireless network that holds a database of the users with prepaid accounts and a balance of each account, and that manages all of the prepaid calls in the network. The PPS-Payphone Interface (30) enables real-time communication between the PPS (10) and a Payphone Application (40). The Payphone Application (40) is a program that runs in the Handset (50). The program may be pre-installed in a handset during the manufacturing process, or it may be downloaded to a handset using downloading systems, such as Binary Runtime Environment for Wireless (BREW), a product of QUALCOMM, Inc., Java 2 platform Micro Edition (J2ME), a product of SUN MICROSYSTEMS, Inc., etc. Alternatively, the Payphone Application (40) can be implemented in the PPS (10), wherein the PPS-Payphone Interface (30) provides real-time communication between the Payphone Application (40) and the Handset (50) as well.

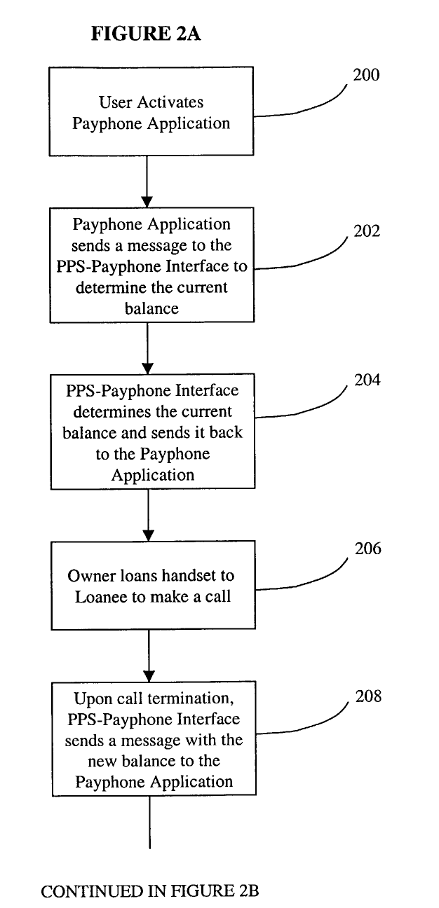

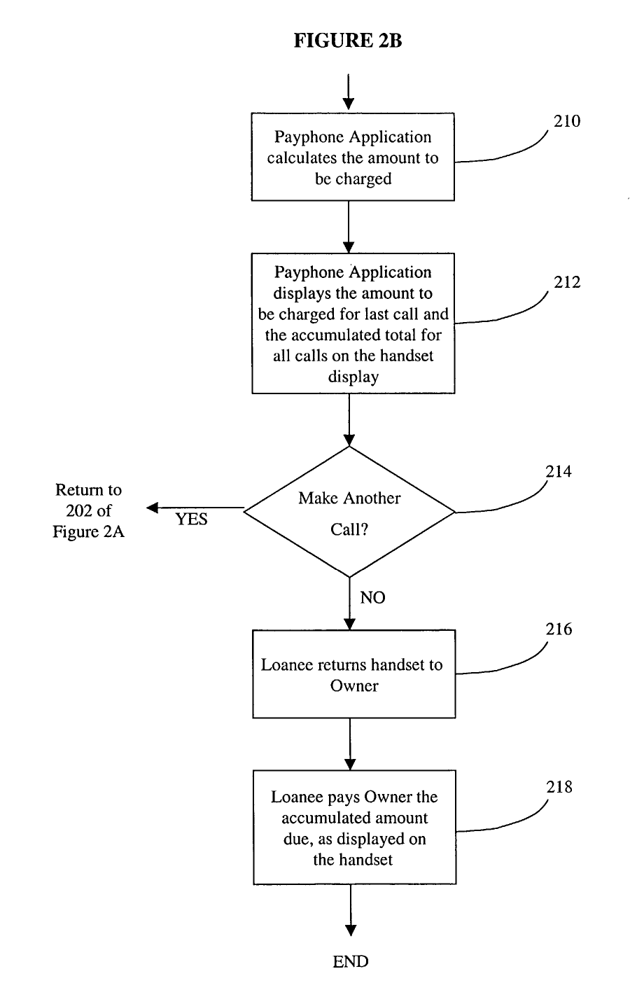

FIGS. 2A and 2B depict an exemplary flow of an operation of the wireless prepaid payphone system of FIG. 1. First, the Owner (60) of the Handset (50) activates the Payphone Application (40) by pressing a key or keys on the Handset (50), or by going through a menu at 200. Indeed, an advantage of having the Payphone Application (40) run in the Handset (50) is that it can be integrated into the existing menu structure of the Handset (50). Accordingly, the actual activation of the Payphone Application (40) is dependent upon the implementation of the Handset (50), and thus may vary between different types of handsets.

Upon activation, the Payphone Application (40) sends a message to the PPS-Payphone Interface (30) to determine the current balance of the Owner (60) at 202. Having determined the current balance of the Owner (60), the PPS-Payphone Interface (30) sends the balance to the Payphone Application (40) at 204, which then may cause the current balance to be displayed on the handset's display screen. The Owner (60) then loans the Handset (50) to the Loanee (70) in order to make a call at 206. The PPS (10) tracks each prepaid call in the wireless network (20) in a conventional manner.

Upon termination of the call, the PPS-Payphone Interface (30) sends a message to the Payphone Application (40) with the new balance at 208. The Payphone Application (40) calculates the amount to be charged, based on the difference between the new balance and the previous balance and including the defined margin at 210. This defined margin/rate can be stored at the PPS (10), for example, by assistance from the Network Operator, by the Owner (60) through the PPS-Payphone Interface (30), etc. The defined margin/rate can be stored in the Handset (50) as well, for example, by being manually input into the Payphone Application (40) by the Owner (60) prior to loaning the Handset (50), etc. Furthermore, the defined margin/rate may vary depending upon factors such as the time and/or day of use, the type of service requested, etc.

The calculated amount to be charged is then displayed on the display of the Handset (50) at 212.

The Loanee (70) may then initiate another call at 214. The amount to be charged for each subsequent call is calculated in the same manner as described above. After each call, the Handset (50) will display the price for each call and the total accumulated price for all the calls thus made by the Loanee (70) at 212.

When the Loanee (70) is done using the Handset (50), he returns it to the Owner (60) at 216. Because the Handset (50) displays the price for each call and the total accumulated price for all the calls made by the Loanee (70), the parties know exactly how much is owed by the Loanee (70) to the Owner (60). Thus, the parties are able to complete their transaction efficiently, effectively, and equitably at 218. Thereafter, the Owner (60) may cause these calculated prices to be reset so that another transaction may be initiated, i.e. loaning the Handset (50) to a different Loanee (70).

Furthermore, all of the calculated prices may be stored, prior to the transaction being restarted, so that the calculated prices may be subsequently retrieved. In this way, a transaction could be interrupted and resumed at a later time. Alternatively, the stored prices could be retrieved at a later point in time, in whole or part, for purposes such as bookkeeping, invoice generation, etc.

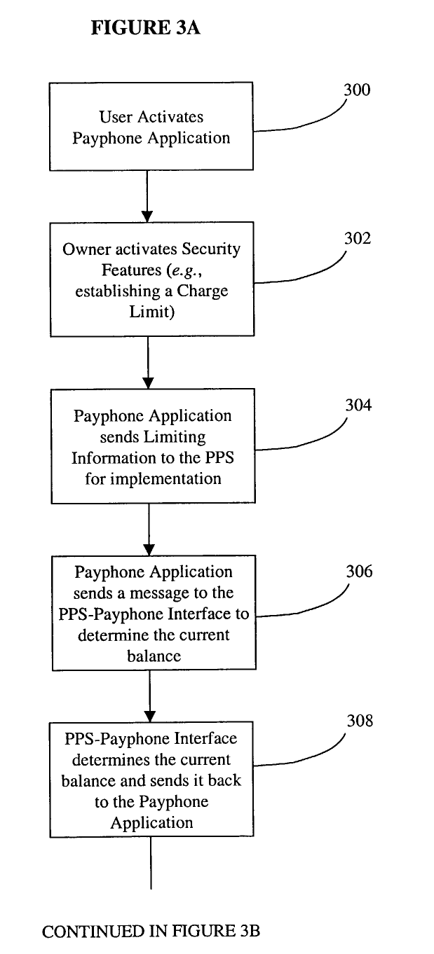

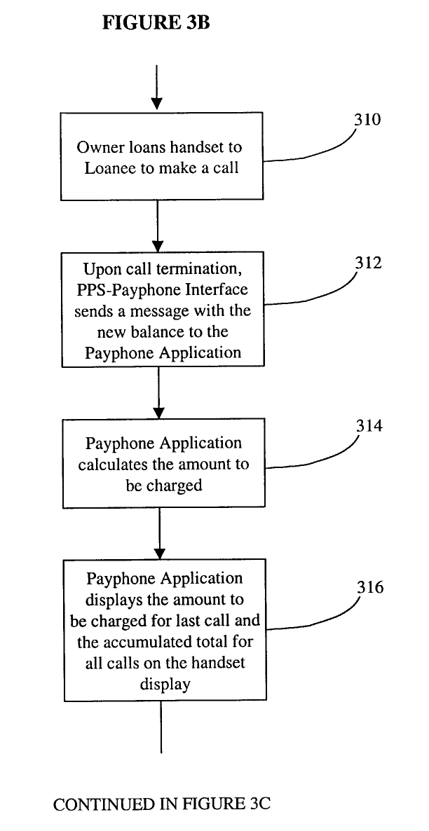

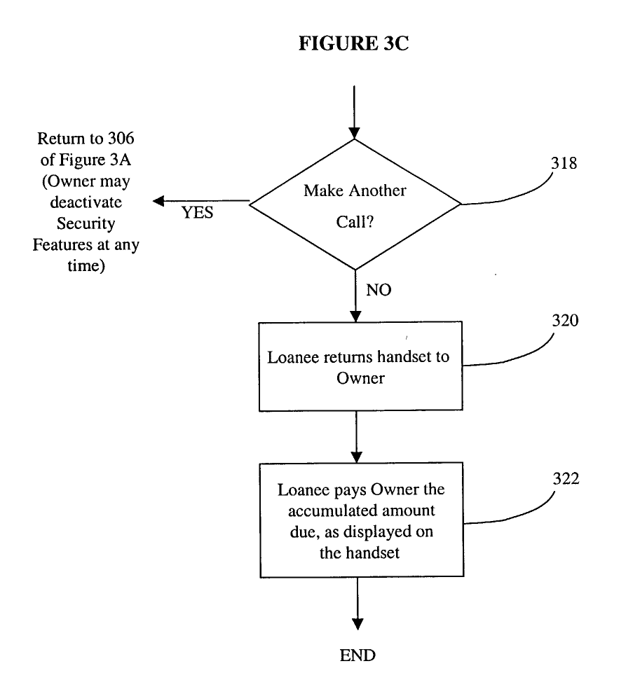

FIGS. 3A-3C depict another exemplary operation flow of the wireless prepaid payphone system of FIG. 1. The cost control application provides the wireless prepaid payphone system with a mechanism to discontinue communication when a preset cost has been incurred. Because the cost limit is preferentially set in the PPS (10), and not the Handset (50), it is much more secure. Establishment of a cost limit reduces the risk of the Loanee (70) stealing calls or even stealing the Handset (50). For example, establishment of a cost limit insures that a Loanee (70) intending to make calls without paying for them afterward, cannot steal the use of the Handset (50) beyond the established limit. Thus, an Owner (60) could set a relatively stringent limit for a Loanee (70) that is not well known to the Owner (60), while setting a relaxed limit for a Loanee (70) that is more well known to the Owner (60) or that exhibits some other indicia of trustworthiness.

First, the Owner (60) of the Handset (50) activates the Payphone Application (40) by pressing a key or keys on the Handset (50), or by going through a menu at 300. The actual activation of the Payphone Application (40) is dependent upon the implementation of the Handset (50), and thus may vary between different types of handsets.

Upon activation, the Payphone Application (40) sends a message to the PPS-Payphone Interface (30) to determine the current balance of the Owner (60) at 306. Also upon activation, the Owner (60) may optionally activate security measures, such as limiting the use of the handset. For example, use of the Handset (50) might be conditioned on entry of a predetermined password by the Loanee (70) prior to initiation of each call. Another exemplary security feature would allow the Owner (60) to specify a period of time after which the Loanee (70) could not make a call without returning the Handset (50) to the Owner (60) to thereby disable or reset the security feature. Other security features are well know in the art, including blocking certain phone services and limiting calls to a certain geographical region. Furthermore, implementation of a cost control application, described below, is facilitated.

For example, the total charge that the Loanee (70) can incur may be limited at 302. If a charge limit is established, the limit information is sent from the Payphone Application (40) to the PPS (10) at 304. The limit is then implemented by the PPS, whereby the PPS can insure that continued communication by the Loanee (70) is not permitted once the charge limit is reached. For example, when the charge limit is reached, the PPS (10) could use the PPS-Payphone Interface (30) to send a message to the Payphone Application (40) instructing the Handset (50) to discontinue the current communication. Alternatively, treating the reached charge limit as an exhaustion of the prepaid amount, other well-known approaches for preventing/terminating a call when an insufficient prepaid balance remains could be employed.

In implementing the charge limit, the charge can be calculated periodically, such as every minute or fraction thereof. Likewise, the PPS (10) can continually calculate an incurred charge and compare the incurred charge to the charge limit. Preferably, in implementing the charge limit, the maximum time length of the call is calculated, based on the charge limit and the rate (including the margin), and a timer is started for this amount of time or less. When the timer expires, either a warning is given to the user or the call is terminated. A timer mechanism consumes less computer resources than periodically recalculating the amount of money (or time) left in the call. If the limit is removed, reset or changed, the original timer request can be cancelled and a new expiration time calculated and a new timer request made. Other well-known mechanisms for implementing charge limits on calls could be used as well. Additionally, a limit may be removed, reset, or changed at any time by the specific authorization of the Owner (60), for example by entering a secret personal identification number (PIN code).

Furthermore, different limits can be established for different loanees and different handsets, and different combinations thereof. Likewise, a limit can be stored by the PPS (10) for later retrieval. Optionally, the Loanee (70) may be alerted at predetermined intervals prior to reaching a limit.

Having determined the current balance of the Owner (60), the PPS-Payphone Interface (30) sends it back to the Payphone Application (40) at 308. The Owner (60) then loans the Handset (50) to the Loanee (70) in order to make a call at 310.

Upon termination of the call, the PPS-Payphone Interface (30) sends a message to the Payphone Application (40) with the new balance at 312. The Payphone Application (40) calculates the amount to be charged, based on the difference between the new balance and the previous balance and including the defined margin at 314. The calculated amount is then displayed on the display of the Handset (50) at 316.

The Loanee (70) may then initiate another call at 318. The amount to be charged for each subsequent call is calculated in the same manner as described above. After each call, the Handset (50) will display the price for each call and the total accumulated price for all the calls thus made by the Loanee (70) at 316.

When the Loanee (70) is done using the Handset (50), he returns it to the Owner (60) at 320. Because the Handset (50) displays the price for each call and the total accumulated price for all the calls made by the Loanee (70), the parties know exactly how much is owed by the Loanee (70) to the Owner (60). Thus, the parties are able to complete their transaction in an efficient, effective, and equitable manner at 322.

Those skilled in the art will understand that for data communication between the PPS-Payphone Interface (30) and the Payphone Application (40), any means of standard data communication in wireless networks may be used, such as Short Messaging System (SMS), General Packet Radio Service (GPRS), Unstructured Supplementary Service Data (USSD), Wireless Access Protocol (WAP), or any other applicable and available data bearer.

In an alternative embodiment, the system provides prepaid phone service in a wired or wireless communications network, such as by a prepaid calling card. Prepaid callings cards are known in the art and allow a user to complete a call by using a calling card. For example, a user who wishes to complete a calling card call needs only dial a toll-free telephone number and then key in the prepaid calling card number (and optional password) printed on the prepaid calling card, followed by the destination telephone number. The call is then completed by the service provider that issued the prepaid calling card after the appropriate checks for the availability and sufficiency of a balance on the account associated with the prepaid calling card number.

Prepaid calling cards offer several advantages over conventional calling cards, such as the elimination of bill payments, certainty about the cost per minute for the call, cheaper rates than calling card calls and ease of use, to name a few.

According to this embodiment, a prepaid server of the system automatically calculates all cost and price information for a phone service, which is then communicated to the user's phone by way of the communications network. For example, the cost and price information can be converted to speech by the prepaid server, communicated to the user's phone by a server interface, and audibly outputted to the user. Furthermore, at the end of a session/series of calls, the prepaid server calculates a total cost incurred, which is then communicated through the communications network to the user's phone by the server interface. The cost control application described in connection with FIGS. 3A-3C can also be implemented in the prepaid calling card embodiment.

Although the invention has been described in connection with various voice call embodiments, the system, according to the invention, supports phone services other than voice calls. For example, facsimile transmissions, SMS/EMS/MMS messaging, web surfing, etc. may be offered as prepaid services at a single flat rate, at different fixed rates, or at a variable rate. The flow operations shown in FIGS. 2A-2B and 3A-3C can be applied to such prepaid services. Even further, the invention can encompass network-independent prepaid scenarios as well, for example, prepaid phone cards, which can be used with either wired or wireless phones.

The system may also implement various security features, including the cost control application, as described above. For example, the system allows an owner of a phone to assign a user an identifier and establish a use limit for the user, wherein both the identifier and the use limit are stored by the prepaid server. Thereafter, to use the phone, the user must enter a valid identifier which the prepaid server can then use to reference the stored use limit. When the user's use limit is reached, the prepaid server can discontinue any communication by the user through the phone. Furthermore, an audible alert can be sounded at predetermined intervals prior to the limit of the user being reached to warn the user that the limit is approaching.

Other modifications and variations to the invention will be apparent to those skilled and the art from the foregoing disclosure and teachings. Thus, while only certain embodiments of the invention have been specifically described herein, it will be apparent that numerous modifications may be made thereto without departing from the spirit and scope of the invention.

There is claimed:

1. A prepaid payphone system for providing payphone service in a communications network, comprising:
a prepaid server containing information representing a prepaid amount of communications network use corresponding to a user, said prepaid server including a payphone interface;
wherein the prepaid server is configured to calculate an amount due for a call; and
wherein said payphone interface is configured to output the amount due to the user in real time.

2. The prepaid payphone system of claim 1, further comprising a payphone application, wherein the payphone application is configured to calculate the amount due for the call instead of the prepaid server.

3. The prepaid payphone system of claim 2, wherein the payphone application is a software program stored in the prepaid server.

4. The prepaid payphone system of claim 2, wherein the prepaid server maintains a current balance of communications network use for the user.

5. The prepaid payphone system of claim 4, wherein the payphone application calculates the amount due for the call by comparing the communications network use balances before and after the call.

6. The prepaid payphone system of claim 2, wherein the calculated amount due for the call includes a predetermined margin.

7. The prepaid payphone system of claim 6, wherein the predetermined margin is a function of the type of prepaid service.

8. The prepaid payphone system of claim 6, wherein the predetermined margin is input by the user.

9. The prepaid payphone system of claim 1, wherein the prepaid server is configured to calculate an accumulated total due for a plurality of calls.

10. The prepaid payphone system of claim 1, wherein the communications network is a wireless communications network.

11. The prepaid payphone system of claim 10, wherein the payphone interface sends a message containing the amount due.

12. The prepaid payphone system of claim 11, wherein the message is sent using one of SMS, EMS, MMS, GPRS, USSD, and WAP.

13. A prepaid payphone system for providing payphone service in a communications network, comprising:
a prepaid server containing information representing a prepaid amount of communications network use corresponding to a user, and representing a current balance, said prepaid server including a payphone interface, and
a payphone application configured to calculate an amount due for a call;
wherein said payphone interface is operable to transfer the amount of the current balance to the payphone application in real time.

14. The prepaid payphone system of claim 13, wherein said communications network is a wireless communications network.

15. The prepaid payphone system of claim 13, further comprising a communications device, and
wherein the payphone application is located in the communications device.

16. The prepaid payphone system of claim 15, wherein the communications device is a wireless communications device.

17. The prepaid payphone system of claim 13, wherein the payphone application is configured to communicate with the prepaid server through the payphone interface to determine a first balance prior to initiation of a call.

18. The prepaid payphone system of claim 17, wherein the payphone application is configured to communicate with the prepaid server through the payphone interface to determine a second balance upon termination of the call.

19. The prepaid payphone system of claim 18, wherein the payphone application is configured to calculate the amount due for the call based at least on a difference between the first balance and the second balance.

20. The prepaid payphone system of claim 19, further comprising a communications device, said communications device including a display portion, and wherein the amount due for the call is displayed on the display portion of the communications device.

21. The prepaid payphone system of claim 20, wherein the payphone application is located in the communications device.

22. The prepaid payphone system of claim 13, wherein the payphone application is configured to calculate an accumulated total due for a plurality of calls.

23. The prepaid payphone system of claim 22, further comprising a communications device,
wherein the payphone application is contained in the communications device, and
wherein the accumulated total due for the calls is displayed on the communications device.

24. The prepaid payphone system of claim 23, wherein the communications device is a wireless communications device.

25. A payphone application, comprising:
software instructions for enabling a computer to perform predetermined operations, and
a computer readable medium bearing the software instructions;
wherein the predetermined operations include:
determining a first balance owed before initiation of a service of a communications network;
when the service is terminated, determining a second balance; and
automatically calculating an amount to be charged for the service, based at least on the difference between the first balance and the second balance.

26. The payphone application of claim 25, wherein the payphone application is located in a communications device.

27. The payphone application of claim 26, wherein the communications device is a wireless device.

28. The payphone application of claim 26, wherein the amount to be charged is displayed on the communications device.

29. The payphone application of claim 25, wherein the amount to be charged is also based on a predetermined margin.

30. A prepaid payphone interface for communicating with a prepaid server, said prepaid server containing information representing a prepaid amount of communications network use corresponding to a user, comprising:
software instructions for enabling a computer to perform predetermined operations, and
a computer readable medium bearing the software instructions;
wherein the predetermined operations include:
upon initiation of a call, automatically accessing the prepaid server to determine a current balance owed and transmitting the current balance; and
upon termination of the call, automatically accessing the prepaid server to determined a new balance owed and transmitting the new balance.

31. The prepaid payphone interface of claim 30, wherein the prepaid payphone interface is integrated with the prepaid server.

32. A method for providing prepaid payphone service, comprising:
upon initiation of a call, determining a first prepaid balance;
upon termination of the call, determining a second prepaid balance;
calculating a cost for the call by determining the difference of the second prepaid balance and the first prepaid balance; and
outputting the calculated cost of the call.

33. The method of claim 32, wherein the calculated cost is displayed on a display portion of a calling device.

34. The method of claim 33, further comprising:
storing the calculated cost of each of a plurality of calls;
calculating a total cost from the stored costs; and
outputting the total cost of the plurality of calls.

35. The method of claim 34, wherein the total cost is displayed on a display portion of a calling device.

36. The method of claim 32, wherein the calculated cost for the call includes a predetermined margin.

37. The method of claim 32, further comprising:
setting a limit on an amount of communications network use that is less than the first prepaid balance; and
discontinuing communication when the limit is reached.

38. The method of claim 37, wherein the limit on use is represented by a maximum accumulated cost.

39. The method of claim 37, further comprising:
alerting a user when the current communications network use of the user is within a predetermined range of the set limit.

40. A cost control method for a prepaid phone service, comprising:
setting a use limit on a prepaid phone service, said use limit applying to a second user;
determining when the use limit is reached; and
discontinuing use of the prepaid phone service by the second user when the use limit is reached.

41. The method of claim 40, further comprising alerting the second user when the use limit is approached by a predefined amount.

42. The method of claim 41, wherein the use limit is represented by a maximum accumulated cost.

43. The method of claim 40, wherein the step of determining when the use limit is reached comprises:
calculating a maximum time length of a call based on the use limit and a margin;
starting a timer for counting down from the maximum time length; and
when the timer expires, determining that the use limit is reached.
